(19) United States
(12) Patent Application Publication
(10) Pub. No.: US 2025/0386850 A1
(43) Pub. Date: Dec. 25, 2025

(54) CONTINUOUS FORMING DEVICE FOR TOFU AND FABRIC BELT

(71) Applicant: HOUSE FOODS AMERICA CORPORATlON, Garden Grove, CA (US)

(72) Inventor: Kazuki YOSHIDA, Garden Grove, CA (US)

(73) Assignee: HOUSE FOODS AMERICA CORPORATlON, Garden Grove, CA (US)

(21) Appl. No.: 18/748,633

(22) Filed: Jun. 20, 2024

(51) Int. Cl. A23P 30/10; A23L 11/45; D03D 15/283

(52) U.S. Cl. CPC A23P 30/10; A23L 11/45; D03D 15/283; D10B 2321/022; D10B 2505/00

(57) ABSTRACT

A continuous forming device for tofu includes: a conveyor circulating a predetermined track including a track parallel to a conveyance passage of coagulated soymilk; another conveyor circulating a predetermined track including a track parallel to the conveyance passage and forming a pair with the conveyor; a fabric belt circulating a predetermined track including a track parallel to the conveyance passage on the outer circumference of the conveyor; and another fabric belt circulating a predetermined track including a track parallel to the conveyance passage on the outer circumference of the other conveyor and forming the conveyance passage between the fabric belt. The fabric belt and the other fabric belt are made of a twill fabric by multifilament made of polypropylene.

### TECHNICAL FIELD

The present disclosure relates to a continuous forming device for tofu and a fabric belt.

### BACKGROUND

A conveyor-type of continuous forming device is used as a device for producing tofu. In the continuous forming device, tofu is continuously produced by compressing coagulated soymilk with a conveyor and a fabric belt.

For example, Patent Literature 1 discloses repeating a process of compressing coagulated soymilk bringing a fabric belt into contact with the coagulated soymilk, and then peeling the fabric belt from the coagulated soymilk to continuously produce tofu.

### PATENT LITERATURE

Patent Literature 1: Japanese Patent Publication No. 6672324

### SUMMARY

However, in a continuous forming device as described in Patent Literature 1, a fabric belt may not peel off well against tofu, thereby a part of the tofu may adhere to the fabric belt and be missing. In addition, in the continuous forming device as described in Patent Literature 1, too much water may be removed during compressing, resulting in producing hard tofu. Missing or hardened tofu have to be discarded, resulting in food loss.

In view of the above problems, an object of the present disclosure is to provide a continuous forming device for tofu and a fabric belt that can improve detachability of the fabric belt against tofu and water retentivity of tofu to be produced.

In order to solve the above problems, a continuous forming device for tofu of a first aspect according to the present disclosure includes: a first conveyor circulating a predetermined track including a track parallel to a conveyance passage of coagulated soymilk; a second conveyor circulating a predetermined track including a track parallel to the conveyance passage and forming a pair with the first conveyor; a first fabric belt circulating a predetermined track including a track parallel to the conveyance passage on the outer circumference of the first conveyor; and a second fabric belt circulating a predetermined track including a track parallel to the conveyance passage on the outer circumference of the second conveyor and forming the conveyance passage between the first fabric belt. The first fabric belt and the second fabric belt are made of a twill fabric by multifilament made of polypropylene.

In addition, the continuous forming device for tofu of a second aspect according to the present disclosure relates to the first aspect, and further includes a crown-shaped roller which is provided at an outlet side of the conveyance passage and supports the first fabric belt provided on an upper side of the conveyance passage.

Furthermore, a fabric belt of a third aspect according to the present disclosure is a fabric belt which compression-forms coagulated soymilk in a continuous forming device for tofu, the fabric belt being made of a twill fabric by multifilament made of polypropylene.

According to a continuous forming device for tofu and a fabric belt in accordance with the present disclosure, detachability of the fabric belt against tofu and water retentivity of tofu to be produced can be improved. Furthermore, in the continuous forming device for tofu and the fabric belt in accordance with the present disclosure, tofu can be produced efficiently, enabling food loss to be reduced.

### BRIEF DESCRIPTION OF DRAWINGS

FIG. 1 is a schematic view illustrating one example of an overall configuration of a continuous forming device for tofu according to an embodiment of the present disclosure.

FIG. 2 is a sectional view of the continuous forming device for tofu taken along the line II-II in FIG. 1.

FIG. 3 is a diagram illustrating evaluated results of water retentivity and adhesion to fabric for a fabric belt in FIG. 1.

FIG. 4 is a diagram illustrating one example of a shape of a driven roller of the continuous forming device for tofu in FIG. 1.

### DETAILED DESCRIPTION

Embodiments of the present disclosure will be described with reference to the accompanying drawings. Note that for facilitating understanding of descriptions, identical components are followed by the same reference sign in each drawing as much as possible, and redundant descriptions are omitted as appropriate.

### EMBODIMENTS

### <<Configuration of Continuous Forming Device for Tofu>>

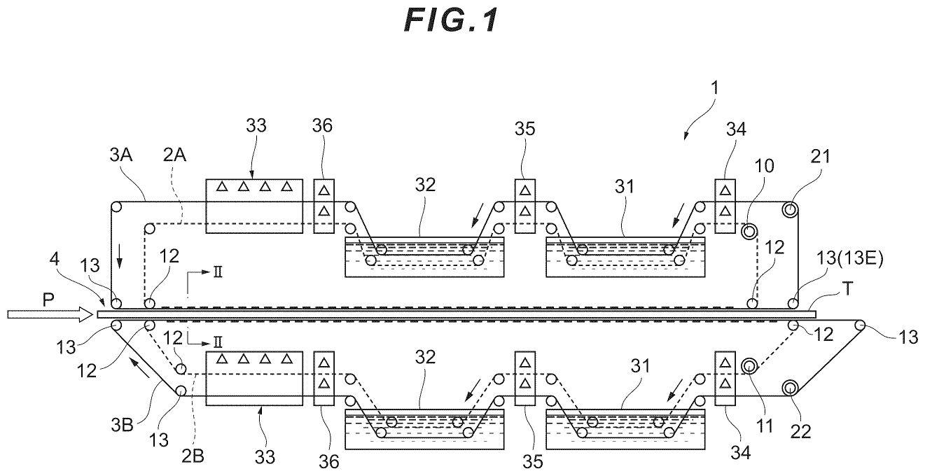

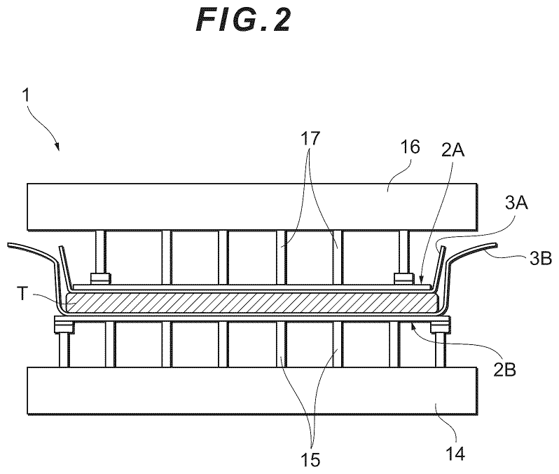

FIG. 1 is a diagram illustrating one example of a rough overall configuration of a continuous forming device 1 for tofu according to an embodiment of the present disclosure. In addition, FIG. 2 is a diagram illustrating a cross section taken along line II-II in FIG. 1. The continuous forming device 1 for tofu is a device in which coagulated soymilk T, which is tofu dough, is fed into a conveyance passage 4 to compression-forms. The coagulated soymilk T is coagulated soymilk produced by a certain device (not shown) by adding a coagulant to soymilk and subjecting the resulting soymilk to coagulate (primary coagulating).

The continuous forming device 1 includes a conveyor 2A, a conveyor 2B, a fabric belt 3A, and a fabric belt 3B as its main components. The conveyor 2A is a first conveyor and the conveyor 2B is a second conveyor. The fabric belt 3 A is a first fabric belt and the fabric belt 3B is a second fabric belt. A passage in which the coagulated soymilk Tis conveyed being sandwiched between the conveyor 2A, the conveyor 2B, the fabric belt 3A, and the fabric belt 3B is referred to as the conveyance passage 4.

The conveyor 2A is an endless conveyor, which is provided over the conveyance passage 4 of the coagulated soymilk T. The conveyor 2B is an endless conveyor, which is provided under the conveyance passage 4 of the coagulated soymilk T. The conveyors 2A and 2B form a pair.

The conveyor 2A is driven by a conveying roller 10 and circulates on a predetermined track over the conveyance passage 4. The conveyor 2B is driven by a conveying roller 11 and circulates on a predetermined track under the conveyance passage 4. The conveying rollers 10 and 11 are each driven by a motor (not shown). The conveyors 2A and 2B are driven for circulation at a constant circulation speed. In addition, a plurality of driven rollers 12 are disposed on circulation tracks of the conveyors 2A and 2B, respectively. The driven rollers 12 follow the conveying roller 10 or 11.

Each of the conveyors 2A and 2B is applied prescribed tension by the driven rollers 12. That is, the conveyors 2A and 2B are guided by the respective driven rollers 12. The driven rollers 12 are tension rollers. This prevents deflection of the tracks of the conveyors 2A and 2B from suppressing and adjusts the conveyors 2A and 2B to circulate on the respective predetermined tracks. Note that a method for applying tension to the conveyors 2A and 2B is not limited to the above.

In addition, as illustrated in FIG. 2, the conveyor 2B is supported by a plurality of support rails 15 erected from a base stage 14 so as to be movable in a conveying direction P. An elevating unit 16 which is supported by an elevating mechanism (not shown) so as to be movable in the top-bottom direction is disposed over the base stage 14. A plurality of support rails 17 are hang down from the elevating unit 16 and press the conveyor 2A uniformly toward the coagulated soymilk T located under it. Note that the conveyor 2B may be configured to press the coagulated soymilk T located over it.

The conveyors 2A and 2B are caterpillar-type conveyors, for example, which comprise a combination of many flat plates and chains. Note that a configuration of the conveyors 2A and 2B is not limited to the above.

The fabric belt 3A is an endless fabric belt, which is provided over the conveyance passage 4 of the coagulated soymilk T. The fabric belt 3B is an endless fabric belt, which is provided under the conveyance passage 4 of the coagulated soymilk T. The fabric belts 3A and 3B form a pair.

The fabric belt 3A is driven by a drive roller 21 and circulates on a predetermined track over the conveyance passage 4. The fabric belt 3A is synchronized with the conveyor 2A and circulates around the outer circumference of the conveyor 2A. The fabric belt 3B is driven by a drive roller 22 and circulates on a predetermined track under the conveyance passage 4. The fabric belt 3B is synchronized with the conveyor 2B and circulates around the outer circumference of the conveyor 2B. The drive rollers 21 and 22 are respectively driven by a motor (not shown). A plurality of driven rollers 13 are disposed on circulation tracks of the fabric belts 3A and 3B, respectively. The driven rollers 13 follow the drive roller 21 or 22.

Each of the fabric belts 3A and 3B is applied prescribed tension by the driven rollers 13. That is, the fabric belts 3A and 3B are guided by the respective driven rollers 13. The driven rollers 13 are tension rollers. This prevents deflection of the tracks of the fabric belts 3A and 3B from suppressing and adjusts the fabric belts 3A and 3B to circulate on the respective predetermined tracks. Note that a method for applying tension to the fabric belts 3A and 3B is not limited to the above.

Out of the respective circulation tracks of the conveyor 2A, the conveyor 2B, the fabric belt 3A, and the fabric belt 3B, tracks of the respective members are arranged in straight lines along the conveyance passage 4 in regions forming the conveyance passage 4. Thus, the conveyors 2A and 2B respectively include the tracks parallel to the conveyance passage 4. The fabric belts 3A and 3B also respectively include the tracks parallel to the conveyance passage 4. Each of the conveyor 2A, the conveyor 2B, the fabric belt 3A, and the fabric belt 3B is arranged in a straight line from an inlet to an outlet of the conveyance passage 4.

Furthermore, the conveyor 2A, the conveyor 2B, the fabric belt 3A, and the fabric belt 3B convey the coagulated soymilk T, which is a conveyance target, to the conveying direction P while sandwiching it in the top-bottom direction. In specific, the conveyor 2A and the fabric belt 3A sandwich the coagulated soymilk T from above, while the conveyor 2B and the fabric belt 3B sandwich the coagulated soymilk T from the bottom. That is, one side of the fabric belt 3A contacts the side of the conveyor 2A, and the other side of the fabric belt 3A contacts the coagulated soymilk T. In addition, one side of the fabric belt 3B contacts the side of the conveyor 2B, and the other side of the fabric belt 3B contacts the coagulated soymilk T. Thus, the fabric belts 3A and 3B are provided sandwiching the conveyance passage 4 between a pair of conveyors 2A and 2B. Therefore, the conveyance passage 4 is formed between the fabric belts 3A and 3B.

The coagulated soymilk T is thereby conveyed while being compressed in the conveyance passage 4. As the coagulated soymilk T is compressed, the water is squeezed out by the fabric belts 3A and 3B, and thereby the water is discharged from the coagulated soymilk T. The coagulated soymilk T then is consolidated and turns to formed tofu. The example of the discharged water includes whey, clear water, warm water, or the like. By continuously compressing the supplied coagulated soymilk T, sheet-like tofu having prescribed forming dimensions is produced.

Tofu refers to as silken tofu (soft tofu) or cotton tofu (firm tofu). The cotton tofu includes soft to hard cotton tofu, hard tofu, dried tofu, or the like. The tofu may be soft cotton tofu, tofu bars, (thick) deep-fried tofu dough, deep-fried silken tofu dough, thin deep-fried tofu or thick deep-fried tofu, fried tofu dough such as seasoned sushi fried tofu, dough of deep-fried tofu mixed with thinly sliced vegetables, or secondary processed products thereof. The secondary processed products may also include frozen or freeze-dried products.

Each track of the conveyor 2A, the conveyor 2B, the fabric belt 3A, and the fabric belt 3B is changed at the outlet of the conveyance passage 4 and returns to the inlet of the conveyance passage 4 to form the circulation track. That is, the circulation track comprises a conveyor track conveying the coagulated soymilk T and a return track returning from the outlet side to the inlet side.

In the return track, the conveyor 2A, the conveyor 2B, the fabric belt 3A, and the fabric belt 3B are performed a cleaning and sterilization processing. The continuous forming device 1 is provided with an alkali cleaning bath 31, an acid cleaning bath 32, and a steam sterilization bath 33 in the return track. Note that the alkali cleaning bath 31, the acid cleaning bath 32, and the steam sterilization bath 33 may be omitted.

The conveyor 2A, the conveyor 2B, the fabric belt 3A, and the fabric belt 3B entered the respective return tracks are cleaned with water in a water cleaning unit 34. In the water cleaning unit 34, cleaning water is sprayed onto the conveyor 2A, the conveyor 2B, the fabric belt 3A, and the fabric belt 3B to remove residues of the coagulated soymilk T, whey, or the like adhered to the conveyor 2A, the conveyor 2B, the fabric belt 3A, and the fabric belt 3B. Then, the conveyor 2A, the conveyor 2B, the fabric belt 3A, and the fabric belt 3B enter the alkali cleaning bath 31. In the alkali cleaning bath 31, the conveyor 2A, the conveyor 2B, the fabric belt 3A, and the fabric belt 3B are immersed in an alkaline liquid and cleaned by decomposing organic substances such as oil and protein.

Then, the conveyor 2A, the conveyor 2B, the fabric belt 3A, and the fabric belt 3B are cleaned with water in a water cleaning unit 35. In the water cleaning unit 35, cleaning water is sprayed onto the conveyor 2A, the conveyor 2B, the fabric belt 3A, and the fabric belt 3B to remove residues of the coagulated soymilk T, whey, or the like adhered to the conveyor 2A, the conveyor 2B, the fabric belt 3A, and the fabric belt 3B. In the water cleaning unit 35, the alkali liquid is also washed away from the conveyor 2A, the conveyor 2B, the fabric belt 3A, and the fabric belt 3B. The conveyor 2A, the conveyor 2B, the fabric belt 3A, and the fabric belt 3B then enter the acid cleaning bath 32. In the acid cleaning bath 32, the conveyor 2A, the conveyor 2B, the fabric belt 3A, and the fabric belt 3B are immersed in acid liquid and cleaned by dissolving inorganic salts such as calcium carbonate (scale). In addition, the alkaline liquid adhered to the conveyor 2A, the conveyor 2B, the fabric belt 3A, and the fabric belt 3B is neutralized by the acid cleaning bath 32.

Furthermore, the conveyor 2A, the conveyor 2B, the fabric belt 3A, and the fabric belt 3B are cleaned with water in a water cleaning unit 36. In the water cleaning unit 36, cleaning water is sprayed onto the conveyor 2A, the conveyor 2B, the fabric belt 3A, and the fabric belt 3B to remove residues of the coagulated soymilk T, whey, or the like adhered to the conveyor 2A, the conveyor 2B, the fabric belt 3A, and the fabric belt 3B. In the water cleaning unit 36, acid liquid is also washed away from the conveyor 2A, the conveyor 2B, the fabric belt 3A, and the fabric belt 3B. The conveyor 2A, the conveyor 2B, the fabric belt 3A, and the fabric belt 3B then enter the steam sterilization bath 33. In the steam sterilization bath 33, vapor is jetted out onto the conveyor 2A, the conveyor 2B, the fabric belt 3A, and the fabric belt 3B to sterilize them. In the steam sterilization bath 33, the conveyor 2A, the conveyor 2B, the fabric belt 3A, and the fabric belt 3B are also heated and sterilized with internal heat. The acid liquid adhered to the conveyor 2A, the conveyor 2B, the fabric belt 3A, and the fabric belt 3B is removed in the steam sterilization bath 33.

Each of the conveyor 2A, the conveyor 2B, the fabric belt 3A, and the fabric belt 3B is cleaned or the like in the return track, returns to the inlet side of the conveyance passage 4, and enters the conveyor track to convey and compress the coagulated soymilk T again.

### <<Fabric of Fabric Belt>>

Next, fabrics of the fabric belts 3A and 3B are described below.

As described above, the fabric belts 3A and 3B are in contact with the coagulated soymilk T during compressing. Therefore, the fabric belts 3A and 3B are members that affect water loss of the coagulated soymilk T. For example, if too much water is removed from the coagulated soymilk T, the amount of water content contained in tofu after the compression can be low, resulting in a hard product. Therefore, it is preferable that the fabric belts 3A and 3B can have a characteristic that prevent the water loss from occurring too quickly in compressing, and accommodate from soft to hard products. An evaluation index for this water loss refers to as “water retentivity”. The water retentivity is an index evaluated the amount of water content (water retention capacity) in tofu after the compression.

In addition, the fabric belts 3A and 3B are in contact with the coagulated soymilk T during compressing, and then are peeled off from tofu to move to the respective return tracks. During peeling, the fabric belts 3A and 3B may not peel off cleanly from the tofu, and a portion of the tofu may adhere to the fabric belts 3A and 3B sides. In such a case, the shape of the surface of the produced tofu may be uneven instead of flat. Thus, it is preferable that the fabric belts 3A and 3B have good detachability from the tofu after the compression. An evaluation index for this detachability refers to as “adhesion to fabric” (detachability). The adhesion to fabric is an index evaluated a state of the tofu adhered to the fabric belts 3A and 3B after compression.

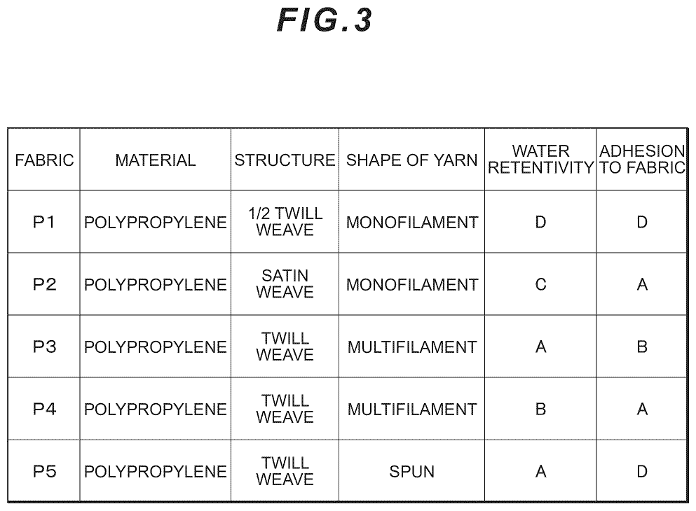

FIG. 3 is a diagram illustrating the evaluated results of the water retentivity and the adhesion to fabric to the fabric belts 3A and 3B using multiple fabrics. In the test according to FIG. 3, each fabric was laid in a mold box, the coagulated soymilk T was put in the box to press, tofu was made, and then the water retentivity and the adhesion to fabric were evaluated. Note that the same tendency as in FIG. 3 was observed when tofu was made using the continuous forming device 1.

FIG. 3 shows characteristics of each fabric, from a fabric P1 to a fabric P5, as a material, a structure, and a shape of yarn. FIG. 3 also shows the evaluated results of the water retentivity and the adhesion to fabric for each of the fabrics at four levels, “D”, “C”, “B”, and “A”, respectively. The evaluated results indicate that “C” is a better result than “D”, “B” is a better result than “C”, and “A” is a better result than “B”. That is, “A” is the most favorable result and “D” is the least favorable result. For example, “D” for the water retentivity indicates that the water retention capacity contained in tofu after the compression is low, resulting in being made hard tofu, and “A” for the water retentivity indicates that the water retention capacity contained in tofu after the compression is high, resulting in being made soft tofu. Having a high water retention capacity and softness of tofu after the compression is a favorable result for the water retentivity. “D” for the adhesion to fabric indicates that the fabric belts 3A and 3B are difficult to peel off from tofu (low detachability), and “A” for the adhesion to fabric indicates that the fabric belts 3A and 3B are easy to peel off from tofu (high detachability). A favorable result for the adhesion to fabric is that the fabric belts 3A and 3B are easy to peel off from tofu.

The fabric P1 results in “D” for both the water retentivity and the adhesion to fabric. The fabric P2 results in “C” for the water retentivity and “A” for the adhesion to fabric. The fabric P3 results in “A” for the water retentivity and “B” for the adhesion to fabric. The fabric P4 results in “B” for the water retentivity and “A” for the adhesion to fabric. The fabric P5 results in “A” for the water retentivity and “D” for the adhesion to fabric.

From the results in FIG. 3, it is found that the fabrics P3 and P4 are suitable in terms of the water retentivity and the adhesion to fabric. That is, the fabrics P3 and P4 are the best fabrics for the fabric belts 3A and 3B used for producing tofu by the continuous forming device 1.

Both the fabrics P3 and P4 are made of polypropylene as a material. In addition, both the fabrics P3 and P4 have a structure of twill weave. Furthermore, both the fabrics P3 and P4 have a shape of multifilament yarn. Therefore, from the results in FIG. 3, it is found that a twill fabric by multifilament made of polypropylene is the most suitable for the fabrics of the fabric belts 3A and 3B used for producing tofu by the continuous forming device 1.

Therefore, it is the most preferable to use the twill fabric by multifilament made of polypropylene for the fabric belts 3A and 3B used in the continuous forming device 1 in FIG. 1. Note that more specifically, the fabric P3 is made of a 2/2 twill weave and the fabric P4 is made of a 2/3 twill weave. Thus, it is preferable to use the 2/2 twill weave or the 2/3 twill weave among the twill weave. In addition, using the fabric made of polypropylene enables to improve the resistance to cleaning in the alkali cleaning bath 31, the acid cleaning bath 32, and the steam sterilization bath 33.

### <<Rollers of Fabric Belt>>

Next, rollers of the fabric belts 3A and 3B will be described below.

As described above, each of the fabric belts 3A and 3B is in straight track along the conveyance passage 4. Therefore, the fabric belts 3A and 3B are tensioned to be in the straight tracks. Specifically, the tracks of the fabric belts 3 A and 3B are adjusted so as to be in the straight tracks by the driven rollers 13 on the inlet side and the driven rollers 13 on the outlet side of the conveyance passage 4. In particular, the driven roller 13 on the outlet side in the fabric belt 3 A refers to as a “driven roller 13E”. The direction of the fabric belt 3A is changed by the driven roller 13E on the outlet side from the track along the conveyance passage 4 (conveyor track) toward the return track. In this case, the direction is changed from the straight track with tension applied along the driven roller 13E, facilitating the fabric belt 3A to meander. When the fabric belt 3A meanders, misalignment of the fabric, folding of the edges, or the like may occur.

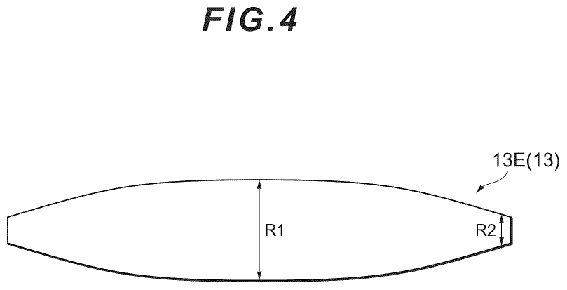

Therefore, the driven roller 13E on the upper outlet side of the conveyance passage 4 is preferably a crown shape. FIG. 4 illustrates one example of a shape of the driven roller 13E. As illustrated in FIG. 4, the crown-shaped driven roller 13E has a shape in which the diameter R1 of the roller is larger at the center portion in the longitudinal direction and the diameter R2 of the roller at the end portion is smaller than the diameter R1. That is, the driven roller 13E has the largest diameter R1 of the roller at the center in the longitudinal direction and the smallest diameter R2 of the roller at the end portion. Making the driven roller 13E, which supports the fabric belt 3A at the outlet side of the conveyance passage 4, to have a crown shape allows the meandering of the fabric in the fabric belt 3A to suppress and the production of tofu to stabilize.

### <<Actions and Effects>>

As described above, in the present embodiment, the continuous forming device 1 for tofu includes the conveyor 2A circulating a predetermined track including a track parallel to the conveyance passage 4 of the coagulated soymilk T; the conveyor 2B circulating a predetermined track including a track parallel to the conveyance passage 4 and forming a pair with the conveyor 2A; the fabric belt 3A circulating a predetermined track including a track parallel to the conveyance passage 4 on the outer circumference of the conveyor 2A; and the fabric belt 3B circulating s predetermined track including s track parallel to the conveyance passage 4 on the outer circumference of the conveyor 2B and forming the conveyance passage 4 between the fabric belt 3A. The fabric belt 3A and the fabric belt 3B are made of a twill fabric by multifilament made of polypropylene.

According to this configuration, the fabric belts 3A and 3B are made of the twill fabric by multifilament made of polypropylene in the continuous forming device 1 for tofu, enabling detachability against tofu to improve. That is, the fabric belts 3A and 3B are more easily peeled off cleanly from the tofu, and unevenness on the surface of the tofu is suppressed. Furthermore, the water retentivity of tofu to be produced can be improved. That is, the flexibility in adjustment of the water content in the continuous forming device 1 for tofu can be increased to accommodate from soft to hard tofu. Thus, it is possible to improve both the detachability of the fabric belts 3A and 3B against tofu and the water retentivity of tofu to be produced. This enables the quality of tofu to stabilize, and thus disposal of tofu or the like that does not meet quality requirements to decrease. That is, food loss can be reduced.

The continuous forming device 1 for tofu further includes the crown-shaped driven roller 13E, which is provided on the outlet side of the conveyance passage 4 and supports the fabric belt 3A on the upper side of the conveyance passage 4.

According to this configuration, the crown-shaped driven roller 13E on the outlet side makes the upper fabric belt 3A, which easily meanders, less likely to meander. This allows tofu to be continuously formed in a stable manner.

### Modifications

Note that the present disclosure is not limited to the present embodiments described above. That is, any design changes made by those skilled in the art to the specific examples described above are also included within the scope of the present disclosure as long as they have the features of the present disclosure. In addition, each element provided in the above embodiments and the following modifications can be combined to the extent technically possible, and the combination of these elements is also included in the scope of the present disclosure to the extent that it includes the features of the present disclosure.

For example, the above embodiments illustrate examples of the specific configuration of the continuous forming device 1. However, the specific device configuration is not limited to the configuration of the continuous forming device 1 illustrated in FIG. 1, as long as the device is capable of continuously forming tofu.

Furthermore, in the above embodiments, the specific circulation tracks of the conveyor 2A, the conveyor 2B, the fabric belt 3A, and the fabric belt 3B are illustrated and described. However, the circulation tracks are not limited to those illustrated in FIG. 1.

1. A continuous forming device for tofu comprising:
a first conveyor circulating a predetermined track including a track parallel to a conveyance passage of coagulated soymilk;
a second conveyor circulating a predetermined track including a track parallel to the conveyance passage and forming a pair with the first conveyor;
a first fabric belt circulating a predetermined track including a track parallel to the conveyance passage on the outer circumference of the first conveyor; and
a second fabric belt circulating a predetermined track including a track parallel to the conveyance passage on the outer circumference of the second conveyor and forming the conveyance passage between the first fabric belt,
wherein the first fabric belt and the second fabric belt are made of a twill fabric by multifilament made of polypropylene.

2. The continuous forming device for tofu according to claim 1, further comprising a crown-shaped roller which is provided at an outlet side of the conveyance passage and supports the first fabric belt provided on an upper side of the conveyance passage.

3. A fabric belt which compression-forms coagulated soymilk in a continuous forming device for tofu, the fabric belt being made of a twill fabric by multifilament made of polypropylene.
